(19) United States
(12) Patent Application Publication
(10) Pub. No.: US 2025/0137474 A1
(43) Pub. Date: May 1, 2025

(54) APPARATUS AND METHOD FOR RECIRCULATING HYDRAULIC FLUID

(71) Applicant: HPDI Technology Limited Partnership, Vancouver (CA)

(72) Inventors: Olaf Baginski, Vancouver (CA); David Sauve, Vancouver (CA)

(21) Appl. No.: 18/834,995

(22) PCT Filed: Jan. 30, 2023
(86) PCT No.: PCT/CA2023/050126

§ 371 Date: Jul. 31, 2024

Related U.S. Application Data
(60) Provisional application No. 63/305,677, filed on Feb. 1, 2022.

(51) Int. Cl. F15B 15/20; F15B 15/14; F15B 21/042

(52) U.S. Cl. CPC F15B 15/204; F15B 15/1447; F15B 15/1485; F15B 21/042; F15B 2211/41563

(57) ABSTRACT

An apparatus and method for recirculating hydraulic fluid includes commanding a fluid switching valve to a first actuating position where pressurized hydraulic fluid moves a piston; detecting when the piston has completed a first stroke; delay commanding the fluid switching valve to a second actuating position, a bypass valve to a bypass position, or a hydraulic pump to stop pressurizing hydraulic fluid, the piston-bypass valve is open such that hydraulic fluid is fluidly communicated into a sub-circuit through an entry port and through the piston-bypass valve wherein a quantity of hydraulic fluid is flushed out of the sub-circuit through an exit port; and command the fluid switching valve to the second actuating position, the bypass valve to the bypass position, or the hydraulic pump to stop pressurizing the hydraulic fluid.

### TECHNICAL FIELD

The present application relates to an apparatus and method for recirculating hydraulic fluid.

### BACKGROUND

Hydraulic fluid systems employ pressurized hydraulic fluid as a medium to transmit energy through the system to enable work and motion to be accomplished. With reference to FIG. 1, a typical hydraulic system 10 includes a pump 30 for pressurizing hydraulic fluid from a reservoir 20 for circulation around the system. A filter 40 removes contaminants from the hydraulic fluid immediately after the pump 30, preferably, before the pressurized hydraulic fluid is delivered to various components in the system through hydraulic line 50. As used herein, hydraulic lines are conduits for fluidly communicating hydraulic fluid. These systems can include a pressure sensor 60 and a temperature sensor 70 for sensing the pressure and temperature parameters respectively of the hydraulic fluid to verify these parameters are within the rated specification of hydraulic system 10. Of the sensors 60 and 70, typically hydraulic fluid systems include a pressure sensor and may not include a temperature sensor. Instead of the pressure sensor, or in addition to, as a safety measure there can be a pressure relief valve 80 for limiting the maximum hydraulic fluid pressure in the system. The pressurized hydraulic fluid is conveyed to end-use hydraulic components such as selector valves and/or actuating units generally represented by reference numeral 100, and returned to reservoir 20 via hydraulic return line 55 through heat exchanger 90 that can use a variety of heat exchange fluids such as engine coolant or air to cool the hydraulic fluid during operation, or to heat the hydraulic fluid in some circumstances such as when hydraulic system 10 is started during cold ambient temperatures. Controller 110, and preferably an electronic controller, can send command signals to and/or receives status signals from pump 30, sensors 60 and 70, and in some circumstances selector valves and/or actuating units 100. In other embodiments, pump 30 can be directly driven by an engine and operated without a clutch such that controller 110 cannot turn off the pump, and this type of pump operation is also contemplated for the disclosed embodiments herein. The durability of the various components in hydraulic fluid system 10 is directly related to the cleanliness of the hydraulic fluid. For some components, the cleanliness has a big impact on their performance, lifetime and the level and frequency of servicing they require.

Referring now to FIG. 2 there is shown hydraulic system 11 that is a particular implementation of hydraulic system 10 and where like parts have like reference numerals and only the differences are discussed. End-use hydraulic components 101 include hydraulic motor 120 that is a double-acting, reciprocating-piston-type actuating unit selectively actuated by controller 111 to effect reciprocating motion of piston rod 190. Piston 170 is connected to piston rod 190 and reciprocates within cylinder 175 between cylinder heads 180 and 185 when pressurized hydraulic fluid is alternately applied to hydraulic chambers 160 and 165. Fluid switching valve 130 and bypass valve 140 are illustrated in a first actuating position for hydraulic motor 120 in FIG. 2. In the first actuating position pressurized hydraulic fluid from hydraulic line 50 is conveyed to hydraulic chamber 165 by hydraulic line 155 causing piston 170 to move towards cylinder head 180 such that piston rod 190 can do work, whereby hydraulic fluid in hydraulic chamber 160 is expelled into hydraulic line 150 through fluid switching valve 130 and into hydraulic return line 55. With reference to FIG. 3, fluid switching valve 130 and bypass valve 140 are illustrated in a second actuating position for hydraulic motor 120. In the second actuating position pressurized hydraulic fluid is conveyed to hydraulic chamber 160 by hydraulic line 150 causing piston 170 to move towards cylinder head 185 such that piston rod 190 can do work, whereby hydraulic fluid in hydraulic chamber 165 is expelled into hydraulic line 155 through fluid switching valve 130 and into hydraulic return line 55. Bypass valve 140 is in a blocking position in the first and second actuating positions whereby it blocks the flow of hydraulic fluid from hydraulic line 50 to 55. With reference now to FIG. 4, bypass valve 140 is illustrated in a bypass position whereby hydraulic fluid in hydraulic line 50 is conveyed to hydraulic return line 55 through bypass valve 140 thereby bypassing hydraulic motor 120. Piston 170 typically employs one or more sealing rings (not shown) to seal against the pressurized hydraulic fluid from leaking between chambers 160 and 165 between piston 170 and cylinder 175. These sealing rings are typically made from non-metallic materials like polymers that can be damaged by contaminants in the hydraulic fluid such that their sealing effectiveness diminishes, which reduces the volumetric efficiency of hydraulic motor 120 and increases parasitic losses and the need for servicing. It is advantageous to improve the cleanliness of hydraulic fluid to reduce the wear on these and other components in the hydraulic systems 10 and 11.

Hydraulic fluid reciprocates over multiple cycles of piston 170 between the first and second actuating positions of hydraulic motor 120 before it is returned to reservoir 20 through hydraulic return line 55. The reason for this is due to hydraulic fluid remaining in hydraulic line 150 at the end of the piston stroke in the first actuating position (when piston 170 is adjacent cylinder head 180) and remaining in hydraulic line 155 at the end of the piston stroke in the second actuating position (when piston 170 is adjacent cylinder head 185), such that this hydraulic fluid does not get flushed into hydraulic return line 55 before fluid switching valve 130 changes to the second and first actuating positions, respectively. The hydraulic fluid that remains in hydraulic lines 150 and 155 at the end of the piston strokes in the first and second actuating positions (the old hydraulic fluid) gets returned to chambers 160 and 165 respectively during the subsequent piston cycle. In the illustrated examples of FIGS. 2 and 3, a maximum volume of chamber 160 (when piston 170 is at cylinder head 185) is greater than a volume of hydraulic line 150, and a maximum volume of chamber 165 (when piston 170 is at cylinder head 180) is greater than a volume of hydraulic line 155, although this is not a requirement, and the opposite may be true. Hydraulic fluid from hydraulic line 50 that enters hydraulic line 150 during the piston stroke in the second actuating position seen in FIG. 3 (the new hydraulic fluid) may mix with the old hydraulic fluid from hydraulic line 150, particularly in chamber 160, to some degree. However, it should be noted that depending on the viscosity of the hydraulic fluid there may be only a small amount of mixing or no mixing at all. Similarly, hydraulic fluid from hydraulic line 50 that enters hydraulic line 155 during the piston stroke in the first actuating position seen in FIG. 2 (the new hydraulic fluid) mixes with the old hydraulic fluid from hydraulic line 155, particularly in chamber 165, to some degree. The mixing of old and new hydraulic fluid is the reason why the old hydraulic fluid eventually gets flushed out into hydraulic return line 55 after several piston cycles have occurred. Once hydraulic fluid from hydraulic line 50 enters sub-circuit 151 it remains in the sub-circuit for several cycles of piston 170 reciprocating between cylinder heads 180 and 185 before the hydraulic fluid is flushed to hydraulic return line 55. Again, it should be noted that if there is no mixing than the old hydraulic fluid gets trapped in sub-circuit 151. A portion of sub-circuit 151 where hydraulic fluid reciprocates back and forth is defined by hydraulic line 150, hydraulic motor 120 and hydraulic line 155. Sub-circuit 151 can also be considered to include fluid switching valve 130 as the fluid switching valve directs pressurized hydraulic fluid into the sub-circuit, and more particularly the fluid switching valve 130 directs pressurized hydraulic fluid into hydraulic line 150 or into hydraulic line 155. The old hydraulic fluid collects and/or creates debris during each piston cycle as it contacts surfaces in hydraulic lines 150 and 155 and in hydraulic motor 120 whereby the old hydraulic fluid becomes more contaminated with debris compared to the new hydraulic fluid from hydraulic line 50 (that has recently been filtered through filter 40). Any particles or debris that may be generated get moved around sub-circuit 151 several times before the fluid is replaced in the sub-circuit and have the potential to cause increased wear through continued abrasion. The components within hydraulic motor 120, particularly the sealing rings (not shown), experience increased wear the more contaminated (that is, the dirtier) the hydraulic fluid is in hydraulic motor 120, and the more the lifetime of these components and the hydraulic motor is reduced.

The viscosity of hydraulic fluids can vary widely over typical hydraulic fluid operating temperatures in applications. For example, when a hydraulic system is employed in a mobile engine application, such as a heavy-duty trucking application, the temperature of the hydraulic fluid can vary from ambient temperature when the heavy-duty truck is started, which can vary between −50 degrees Celsius (° C.) and +50° C. for example, to a desired operating temperature of the hydraulic fluid that typically is between 70 to 80° C., although in other applications the desired operating temperature range can vary between 50° C. and 90° C. An exemplary hydraulic fluid used in some heavy-duty trucking applications has a kinematic viscosity of approximately 345 centistokes (cSt) at −25° C. and 18 cSt at 75° C., which is more than an order of magnitude difference in viscosity between possible hydraulic fluid operating temperatures. During a cold start the hydraulic fluid is recirculated and heated by heat exchanger 90 seen in FIGS. 1, 2 and 3 to elevate the temperature of the hydraulic fluid to its operating temperature, and to create a temperature homogenous mixture of hydraulic fluid within hydraulic systems 10 and 11. It takes substantially longer to form a temperature homogenous mixture of hydraulic fluid in hydraulic system 11 seen in FIGS. 2 and 3 due to the capture of hydraulic fluid within hydraulic motor 120 over several cycles of piston 170 as described above.

The state of the art is lacking in techniques for recirculating hydraulic fluid. The present apparatus and method provide a technique for recirculating hydraulic fluid.

### SUMMARY

An improved apparatus for recirculating hydraulic fluid in a hydraulic system. The hydraulic system can include a reservoir of hydraulic fluid, a hydraulic pump, a bypass valve, a fluid switching valve, a sub-circuit and a controller. The hydraulic pump pressurizes the hydraulic fluid from the hydraulic fluid reservoir. The sub-circuit includes a hydraulic motor and a first hydraulic line and a second hydraulic line connecting the hydraulic motor to the fluid switching valve. Hydraulic fluid enters the sub-circuit through an entry port and leaves the sub-circuit through an exit port. The hydraulic motor includes a piston dividing a cylinder between a first chamber and a second chamber. The first chamber is between the piston and a first cylinder head and is connected to the first hydraulic line. The second chamber is between the piston and a second cylinder head and is connected to the second hydraulic line. The piston is reciprocatable between the first cylinder head and the second cylinder head. A piston-bypass valve allows selective fluid communication of hydraulic fluid between the first chamber and the second chamber. The controller is operatively connected to the fluid switching valve and is programmed to command a first actuating position and a second actuating position. In the first actuating position the fluid switching valve supplies pressurized hydraulic fluid to the second chamber through the second hydraulic line. In the second actuating position the fluid switching valve supplies pressurized hydraulic fluid to the first chamber through the first hydraulic line. The controller is operatively connected to the bypass valve and is programmed to command the bypass valve to a bypass position where pressurized hydraulic fluid bypasses the sub-circuit. The improved apparatus includes the controller programmed to command the fluid switching valve to the first actuating position, and where the piston-bypass valve is closed such that pressurized hydraulic fluid moves the piston towards the first cylinder head; detect when the piston has completed a first stroke and is adjacent the first cylinder head; delay commanding (i) the fluid switching valve to the second actuating position, (ii) the bypass valve to the bypass position, or (iii) the hydraulic pump to stop pressurizing the hydraulic fluid, the piston-bypass valve is open such that hydraulic fluid is fluidly communicated into the sub-circuit through the entry port and through the piston-bypass valve wherein a quantity of hydraulic fluid is flushed out of the sub-circuit through the exit port; and command (i) the fluid switching valve to the second actuating position, (ii) the bypass valve to the bypass position, or (iii) the hydraulic pump to stop pressurizing the hydraulic fluid.

The piston-bypass valve can be a shuttle valve configured in the piston, where pressurized hydraulic fluid closes the shuttle valve in the first actuating position at the beginning of the first stroke, and where the shuttle valve opens when the piston completes the first stroke. Alternatively, the controller can be operatively connected with the piston-bypass valve and programmed to command the piston-bypass valve to close at the beginning of the first stroke and to open when the first stroke is completed, and when the controller commands the fluid switching valve to the second actuating position, the controller can also command the piston-bypass valve to close. In other embodiments, between the steps of detecting and delaying, the controller can be further programmed to stop the hydraulic pump and then restart the hydraulic pump after a time interval, or between the steps of detecting and delaying, the controller can be further programmed to command the bypass valve to the bypass position and then to a non-bypass position after a time interval.

In further embodiments, when the fluid switching valve was commanded to the second actuating position, the controller can be further programmed to detect when the piston has completed a second stroke and is adjacent the second cylinder head; delay commanding (i) the fluid switching valve to the first actuating position, (ii) the bypass valve to the bypass position, or (iii) the hydraulic pump to stop pressurizing the hydraulic fluid, the piston-bypass valve is open such that hydraulic fluid is fluidly communicated into the sub-circuit through the entry port and through the piston-bypass valve wherein the quantity of hydraulic fluid is flushed out of the sub-circuit through the exit port; and command (i) the fluid switching valve to the first actuating position, (ii) the bypass valve to the bypass position, or (iii) the hydraulic pump to stop pressurizing the hydraulic fluid.

The bypass valve can be part of the fluid switching valve, whereby the fluid switching valve is actuatable to the first actuating position, the second actuating position and the bypass position. The quantity of hydraulic fluid that is flushed out of the sub-circuit can be greater than, equal to or less than a fluid volume of the sub-circuit. The quantity of hydraulic fluid flushed out of the sub-circuit can be the quantity of hydraulic fluid flushed when a temperature of the hydraulic fluid is within a desired operating temperature range, and preferably the desired operating temperature range is between 50 degrees Celsius and 90 degrees Celsius. The quantity of hydraulic fluid flushed out of the sub-circuit can be the quantity of hydraulic fluid flushed after a flush time-interval. The quantity of hydraulic fluid flushed out of the sub-circuit can be the quantity of hydraulic fluid flushed when a pressure of hydraulic fluid decreases below a desired value.

An improved method for recirculating hydraulic fluid in the hydraulic system includes supplying pressurized hydraulic fluid to the second chamber and closing the piston-bypass valve to move the piston towards the first cylinder head; detect when the piston has completed a first stroke and is adjacent the first cylinder head; delaying (i) supplying pressurized hydraulic fluid to the first chamber and closing the piston-bypass valve to cause the piston to move towards the second cylinder head, bypassing the pressurized hydraulic fluid from the sub-circuit, or (iii) stopping the hydraulic pump that pressurizes the hydraulic fluid through the piston-bypass valve; the piston-bypass valve is open such that hydraulic fluid is fluidly communicated into the sub-circuit through the entry port and through the piston-bypass valve wherein a quantity of hydraulic fluid is flushed out of the sub-circuit through the exit port; and performing after the quantity of hydraulic fluid is flushed out of the sub-circuit (i) supplying pressurized hydraulic fluid to the first chamber and closing the piston-bypass valve to cause the piston to move towards the second cylinder head, (ii) bypassing the pressurized hydraulic fluid from the sub-circuit, or (iii) stopping the hydraulic pump from pressurizing the hydraulic fluid.

In further embodiments, between the steps of detecting and delaying, the method can include stopping a hydraulic pump that pressurizes and supplies hydraulic fluid to the sub-circuit and then restarting the hydraulic pump after a time interval, or between the steps of detecting and delaying, the method can include bypassing hydraulic fluid from the sub-circuit and then supplying the hydraulic fluid to the sub-circuit after a time interval.

In still other embodiments, when pressurized hydraulic fluid was supplied to the first chamber and the piston-bypass valve was closed to cause the piston to move towards the second cylinder head, the method can include detecting when the piston has completed a second stroke and is adjacent the second cylinder head; delaying (i) supplying pressurized hydraulic fluid to the second chamber and closing the piston-bypass valve to cause the piston to move towards the first cylinder head, (ii) stopping the hydraulic pump that pressurizes the hydraulic fluid through the piston-bypass valve, or (iii) bypassing the pressurized hydraulic fluid from the sub-circuit, the piston-bypass valve is open such that hydraulic fluid is fluidly communicated into the sub-circuit through the entry port and through the piston-bypass valve wherein the quantity of hydraulic fluid is flushed out of the sub-circuit through the exit port; and performing after the quantity of hydraulic fluid is flushed out of the sub-circuit (i) supplying pressurized hydraulic fluid to the second chamber and closing the piston-bypass valve to cause the piston to move towards the first cylinder head, (ii) stopping the hydraulic pump from pressurizing the hydraulic fluid, or (iii) bypassing the pressurized hydraulic fluid from the sub-circuit.

The invention is not limited to the summary above and includes further features disclosed in the embodiments in the written description of exemplary embodiments herein.

### BRIEF DESCRIPTION OF THE DRAWINGS

The accompanying drawings, which are incorporated into and constitute a part of the specification, illustrate specific embodiments of the apparatus, systems, and methods and, together with the general description above, and the detailed description of the specific embodiments, serve to explain the principles of the apparatus, systems, and methods.

FIG. 1 is a schematic view of a hydraulic system in the prior art.

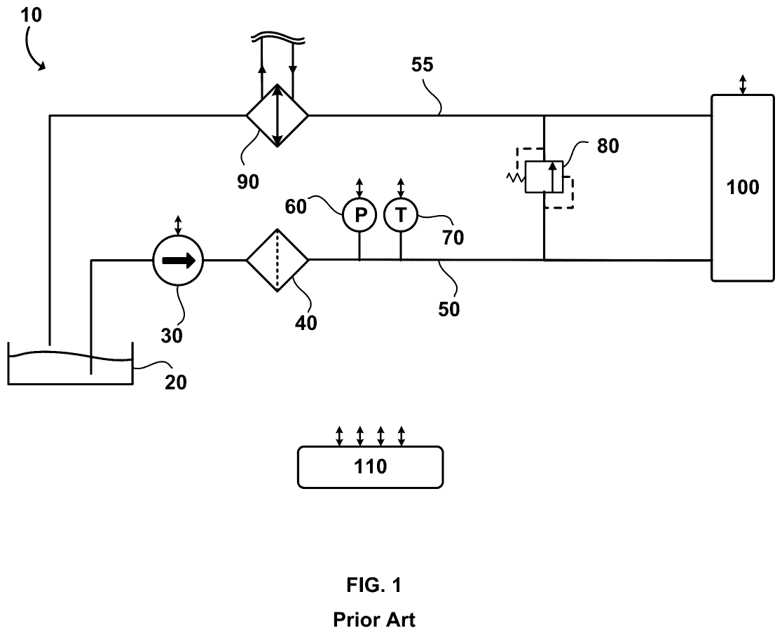

FIG. 2 is a schematic view of another hydraulic system in the prior art shown in a first actuating position.

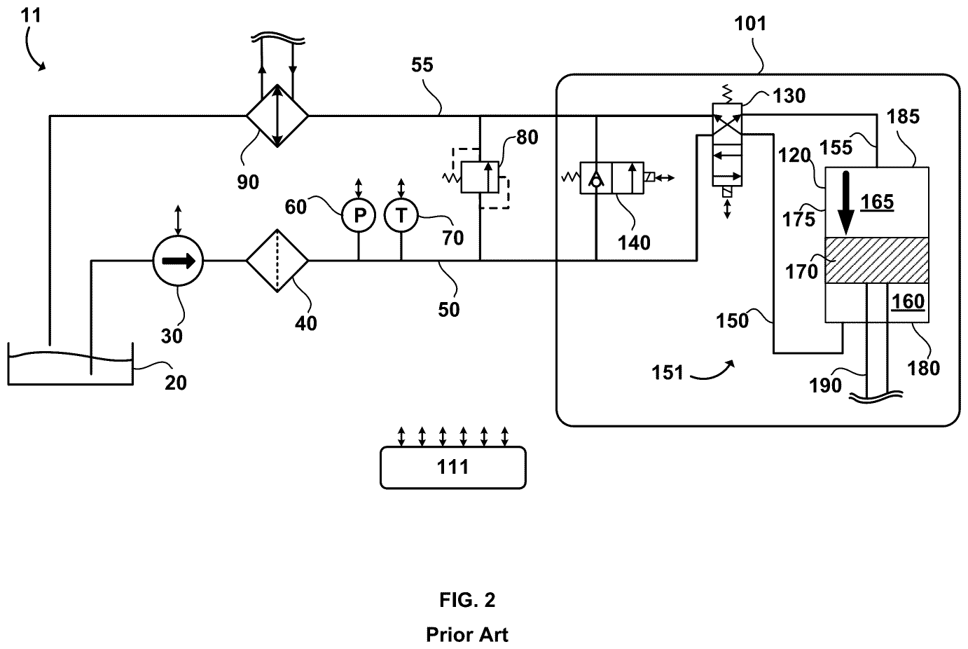

FIG. 3 is a schematic view of the hydraulic system of FIG. 2 shown in a second actuating position.

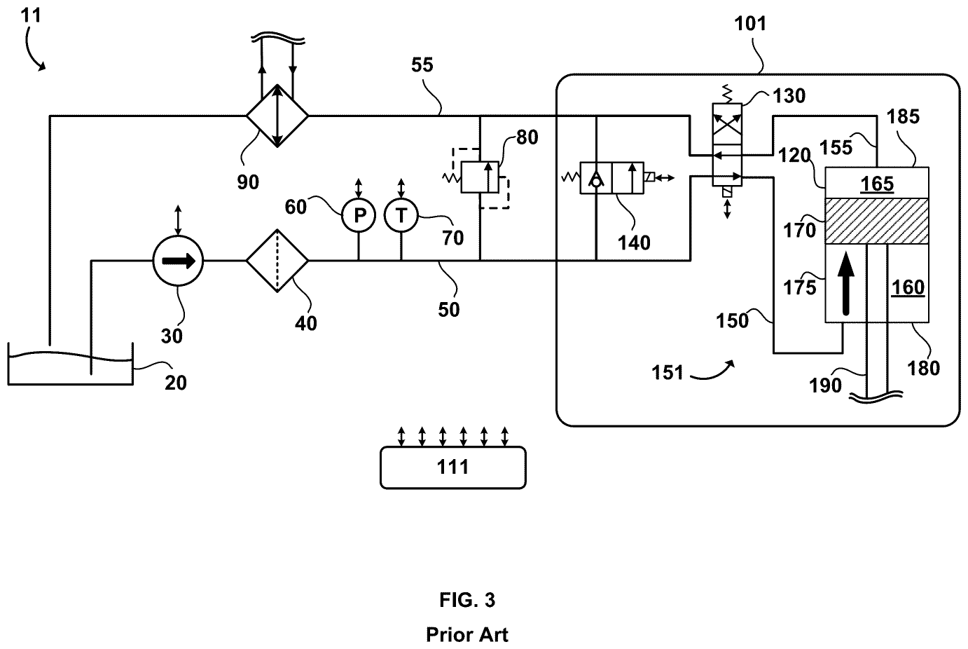

FIG. 4 is a schematic view of the hydraulic system of FIG. 2 shown in a bypass position.

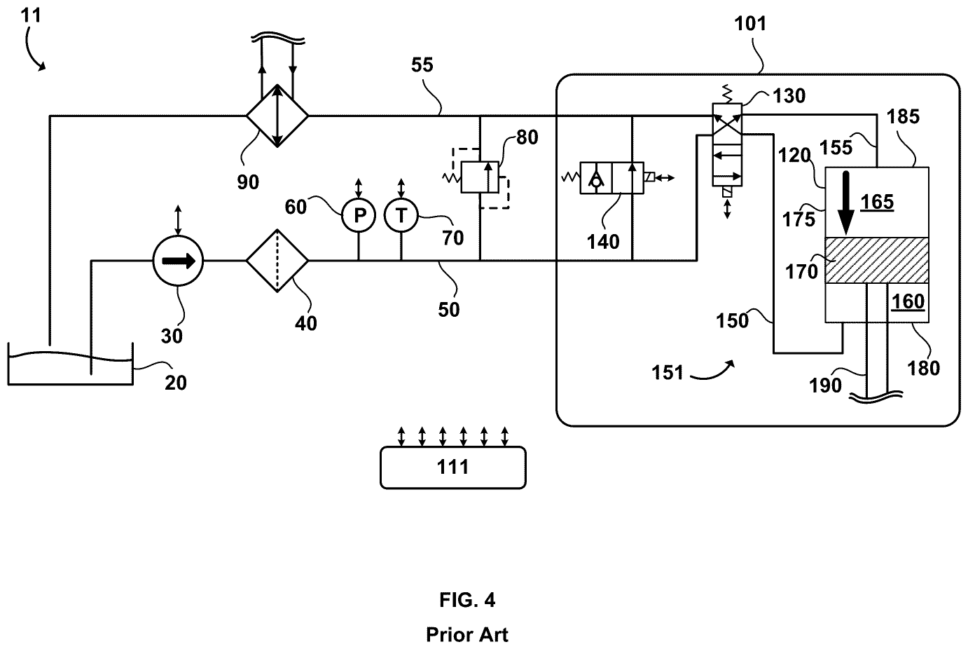

FIG. 5 is a schematic view of a hydraulic system shown in a first actuating position according to an embodiment.

FIG. 6 is a detailed view of a portion of the hydraulic system of FIG. 5 with a shuttle valve shown in a first closed position.

FIG. 7 is a detailed view of a portion of the hydraulic system of FIG. 5 with a shuttle valve shown in a first open position.

FIG. 8 is a schematic view of the hydraulic system of FIG. 5 shown in a second actuating position.

FIG. 9 is a detailed view of a portion of the hydraulic system of FIG. 8 with a shuttle valve shown in a second closed position.

FIG. 10 is a detailed view of a portion of the hydraulic system of FIG. 8 with a shuttle valve shown in a second open position.

FIG. 11 is a schematic view of a hydraulic system shown in a first actuating position according to another embodiment.

FIG. 12 is a schematic view of the hydraulic system of FIG. 11 shown in a second actuating position.

FIG. 13 is a flow chart view of an algorithm for operating the hydraulic systems of FIGS. 5 and 11 according to an embodiment.

FIG. 14 is a flow chart view of an algorithm for operating the hydraulic systems of FIGS. 5 and 11 according to another embodiment.

FIG. 15 is a flow chart view of an algorithm for operating the hydraulic systems of FIGS. 5 and 11 according to yet another embodiment.

FIG. 16 is a flow chart view of an algorithm for operating the hydraulic systems of FIGS. 8 and 12 according to an embodiment.

### DETAILED DESCRIPTION

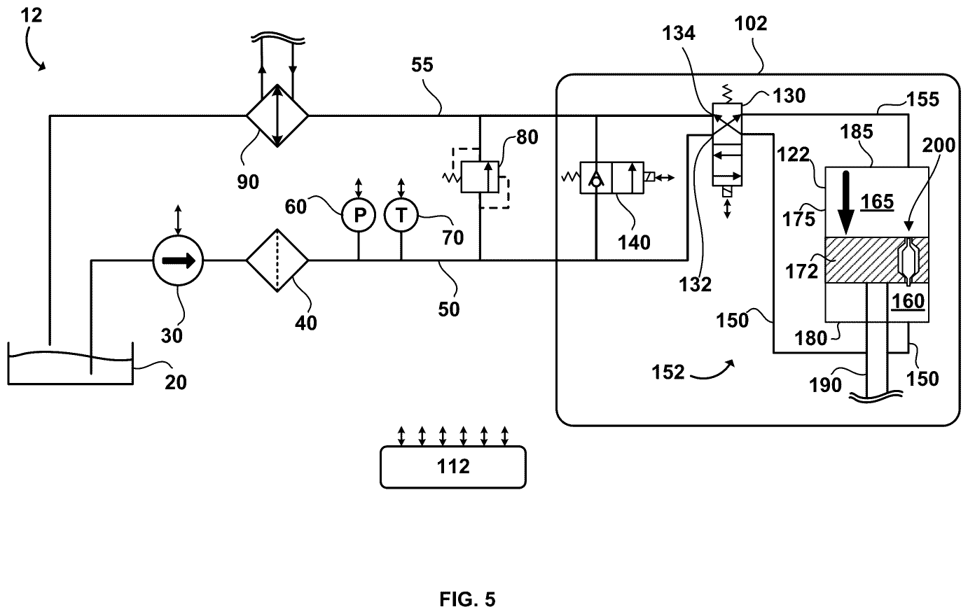

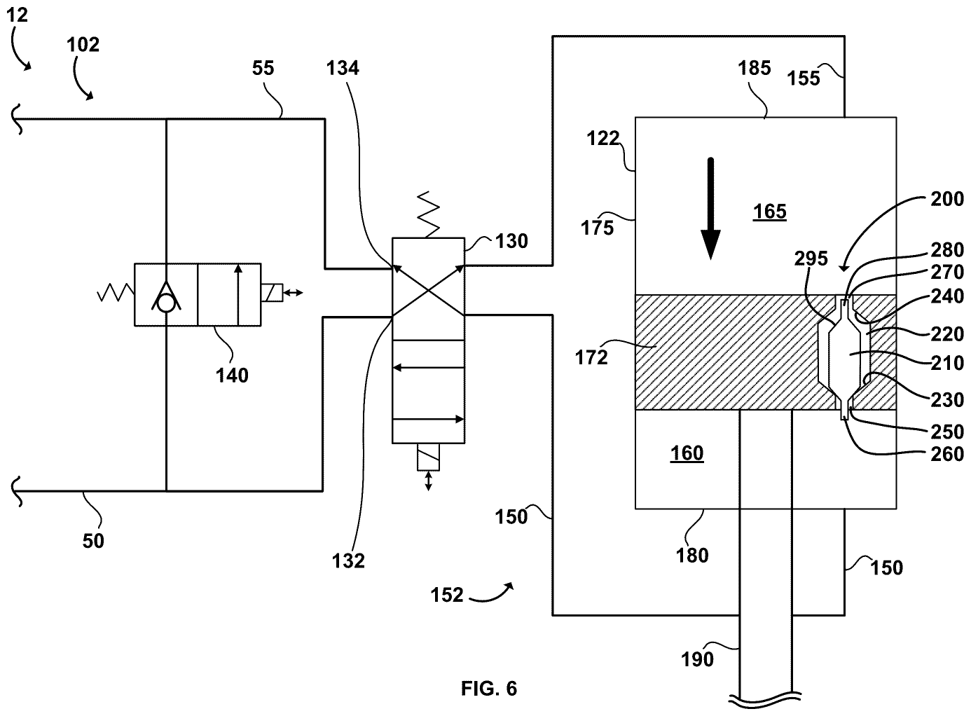

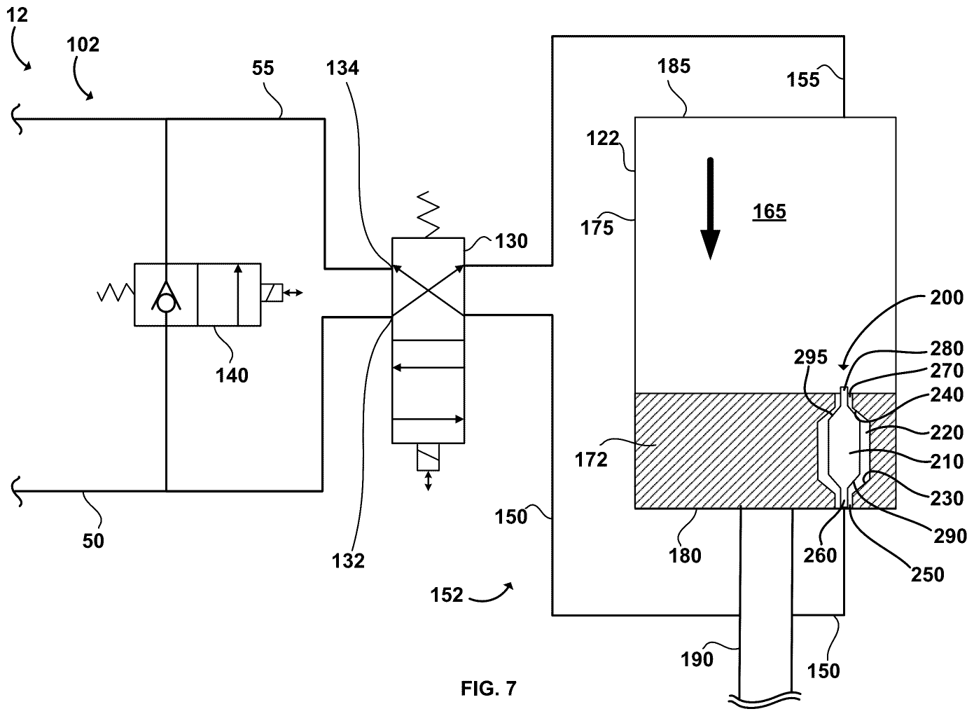

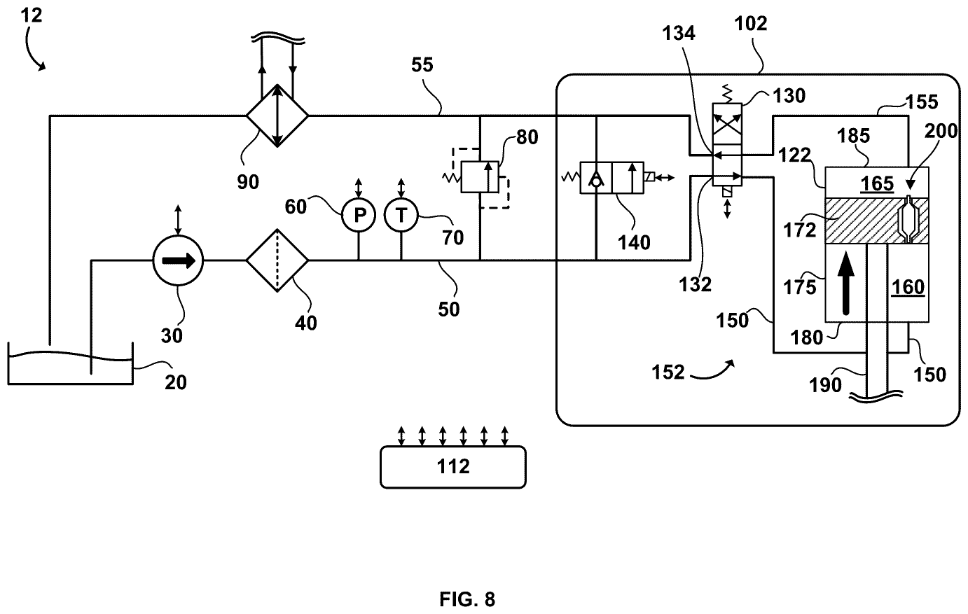

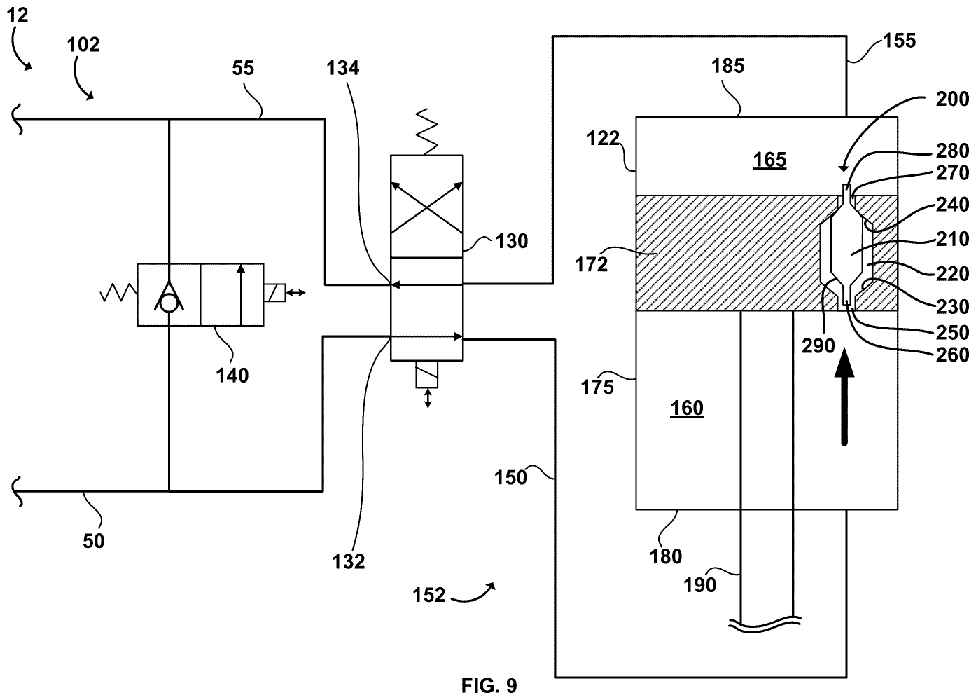

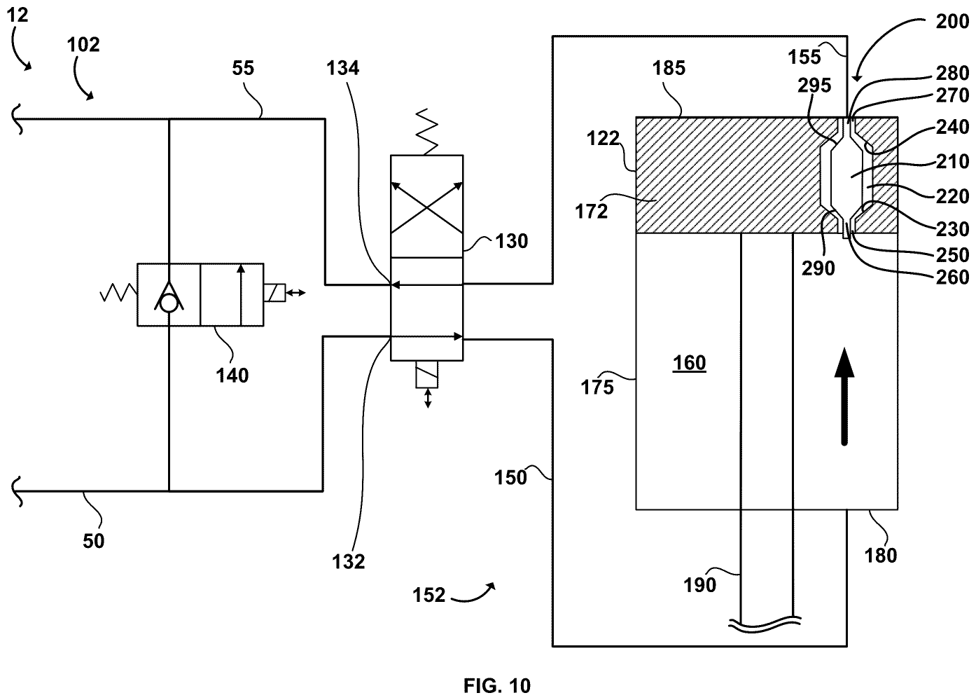

Referring to FIGS. 5 and 8, there is shown hydraulic system 12 according to an embodiment that has similar parts as hydraulic systems 10 and 11 where like parts in this in other embodiments have like references numerals and only the differences are discussed. Hydraulic motor 122 in end-use hydraulic components 102 is a double-acting, reciprocating-piston-type hydraulic motor that includes piston-bypass valve 200 that in the illustrated embodiment is a shuttle valve configured in piston 172. As used herein, double-acting, reciprocating-piston-type hydraulic motor refers to pressurized hydraulic fluid selectively acting in chamber 160 to cause piston 172 to move towards cylinder head 185, and chamber 165 to cause piston 172 to move towards cylinder head 180. Hydraulic motor 122 can be part of a reciprocating-piston pump, where piston rod 190 actuates a pumping piston (not shown) reciprocating in a pumping cylinder (not shown). Examples of reciprocating-piston pumps are cryogenic pumps for pressurizing cryogenic fluids, where the cryogenic pump can include a single-acting or double-acting piston, and gas compressors for pressurizing, for example, gaseous fuels. In exemplary embodiments the cryogenic fluids and gaseous fuels can be hydrogen, methane, propane, natural gas and mixtures thereof. The cryogenic pump can also be employed to pressurize propane stored in liquefied form but above cryogenic temperatures that are typically defined as temperatures from −150° C. to absolute zero (−273° C.). Returning to FIGS. 5 and 8, pressurized hydraulic fluid enters sub-circuit 152 through entry port 132 and hydraulic fluid leaves sub-circuit 152 through exit port 134. A fluid volume of sub-circuit 152 is at least a sum of fluid volumes of hydraulic lines 150 and 155 and of hydraulic motor 122. The fluid volume of hydraulic motor 122 is a sum of fluid volumes of chambers 160 and 165 and cavity 220 less a volume of valve member 210 (best seen in FIGS. 6 and 9). As used herein, a sub-circuit is a part of a hydraulic system. In other embodiments hydraulic systems can include one or more sub-circuits fluidly connected in parallel or in series, where each sub-circuit can be like sub-circuit 152 or different, and where each sub-circuit has the problem of trapped hydraulic fluid due to a reciprocating cycle. Piston-bypass valve 200 functions to selectively allow fluid flow through piston 172 as will be described in more detail below. Piston-bypass valve 200 is illustrated in a first closed position in FIGS. 5 and 6 and a first open position in FIG. 7 where fluid switching valve 130 and bypass valve 140 are illustrated in the first actuating position for hydraulic motor 122. Piston-bypass valve 200 is illustrated in a second closed position in FIGS. 8 and 9 and a second open position in FIG. 10 where fluid switching valve 130 and bypass valve 140 are illustrated in the second actuating position for hydraulic motor 122. Although a volume of chamber 160 in the first open position in FIG. 7 is illustrated as zero, this is not a requirement and in other embodiments chamber 160 can a non-zero minimum volume, also known as a residual volume, when piston 172 is at the end of stroke adjacent cylinder head 180. Similarly, a volume of chamber 165 in the second open position in FIG. 10 is illustrated as zero, this is not a requirement and in other embodiments chamber 165 can a non-zero minimum volume or residual volume when piston 172 is at the end of stroke adjacent cylinder head 185. Bypass valve 140 can be part of fluid switching valve 130, in other embodiments, such that the fluid switching valve is actuatable to the first actuating position, the second actuating position and the bypass position. With reference to FIGS. 6-7 and 9-10, valve member 210 is moveable in valve cavity or bore 220 between valve seat 230 and valve seat 240. Valve cavity 220 includes opening 250 in valve seat 230 through which protruding portion 260 of valve member 210 can protrude into chamber 160. Similarly, valve cavity 220 includes opening 270 in valve seat 240 through which protruding portion 280 of valve member 210 can protrude into chamber 165. Valve member 210 and cavity 220 can be part of an assembly including a cylindrical body (not shown) in which the cavity is located, and where the assembly is inserted into a bore (not shown) in piston 172. Alternatively, piston 172 can be divided into a first portion and a second portion where the second portion connects (longitudinally) with the first portion thereby capturing valve member 210 within cavity 220. Pressurized hydraulic fluid in chamber 165 (during the first actuating position) causes scaling surface 290 of valve member 210 (best seen in FIG. 7) to abut valve seat 230 (best seen in FIG. 6) thereby creating a fluid tight seal when piston-bypass valve 200 is in the first closed position that substantially reduces and preferably prevents hydraulic fluid from flowing from chamber 165 through piston-bypass valve 200 into chamber 160. Protruding portion 260 protrudes into chamber 160 when piston-bypass valve 200 is in the first closed position. Pressurized hydraulic fluid in chamber 160 (during the second actuating position) causes scaling surface 295 of valve member 210 (best seen in FIG. 10) to abut valve seat 240 (best seen in FIG. 9) thereby creating a fluid tight seal when piston-bypass valve 200 is in the second closed position that substantially reduces and preferably prevents hydraulic fluid from flowing from chamber 160 through piston-bypass valve 200 into chamber 165. Protruding portion 280 protrudes into chamber 165 when piston-bypass valve 200 is in the second closed position.

In operation, when piston 172 nears cylinder head 180 during the first actuating position, as illustrated in FIG. 6 with piston-bypass valve 200 in the first closed position, eventually protruding portion 260 abuts cylinder head 180 before the piston causes valve member 210 to lift off valve seat 230 thereby allowing pressurized hydraulic fluid to flow through piston 172 through piston-bypass valve 200 in the first open position illustrated in FIG. 7, which causes a drop in hydraulic fluid pressure in hydraulic line 50 as sensed by pressure sensor 60. The drop in pressure is detected by controller 112 that then actuates end-use components 102 to switch to the second actuating position where pressurized hydraulic fluid starts entering chamber 160 and begins acting on valve member 210 to move towards valve seat 240 until piston-bypass valve 200 is in the second closed position at which point the pressurized hydraulic fluid causes piston 172 to move towards cylinder head 185. When piston 172 nears cylinder head 185 during the second actuating position, as illustrated in FIG. 9 with piston-bypass valve 200 in the second closed position, eventually protruding portion 280 abuts cylinder head 185 before the piston causes valve member 210 to lift off valve seat 240 thereby allowing pressurized hydraulic fluid to flow through piston 172 through piston-bypass valve 200 in the second open position illustrated in FIG. 10, which causes a drop in hydraulic fluid pressure in hydraulic line 50 as sensed by pressure sensor 60. Controller 112 detects the drop in hydraulic fluid pressure and can actuate end-use components 102 to switch to the first actuating position to begin repeating the cycle, when this is the desired operation. This operation of piston-bypass valve 200 in hydraulic motor 122 is described in more detail in Applicant's U.S. Pat. No. 7,739,941 issued on Jun. 22, 2010, and U.S. Pat. No. 10,385,890 issued on Aug. 20, 2019. In other embodiments other techniques can be employed to detect end of piston stroke that do not include detecting the drop in hydraulic fluid pressure after piston-bypass valve 200 opens when valve member 210 abuts either cylinder head 180 or 185. For example, proximity sensors, linear displacement sensors and linear position sensors can be employed to detect the position of piston 172. Alternatively, or additionally a volumetric flow rate of hydraulic fluid into chambers 160 and 165 and elapsed time can be employed to calculate the displacement of piston 172. The volumetric flow rate can be estimated based on the operation of hydraulic fluid pump 30, alternatively or additionally, volumetric flow rate sensors or mass flow rate sensors (along with measurements of hydraulic fluid pressure and temperature) can be employed to determine the volumetric flow rate of hydraulic fluid.

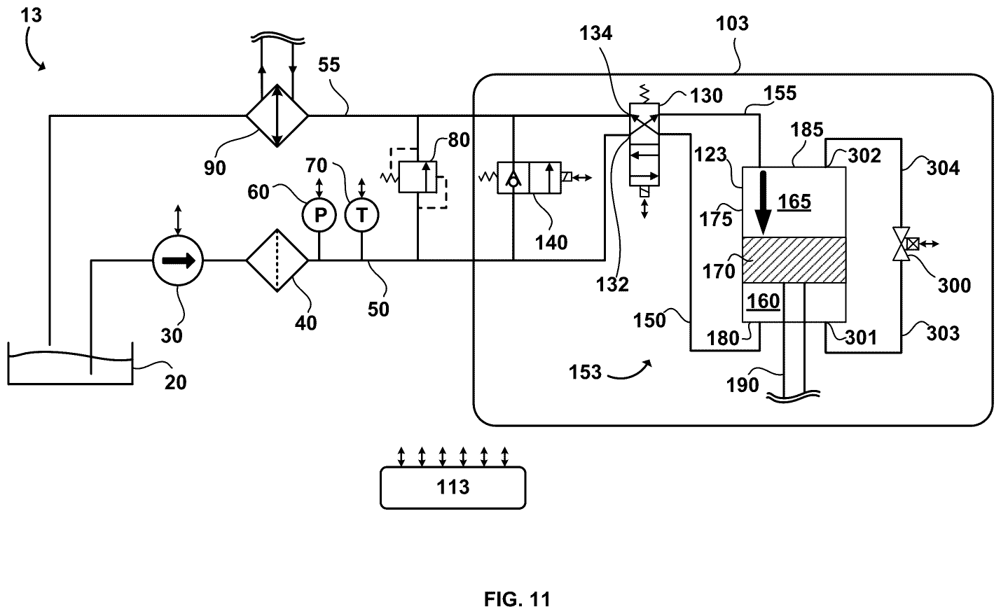

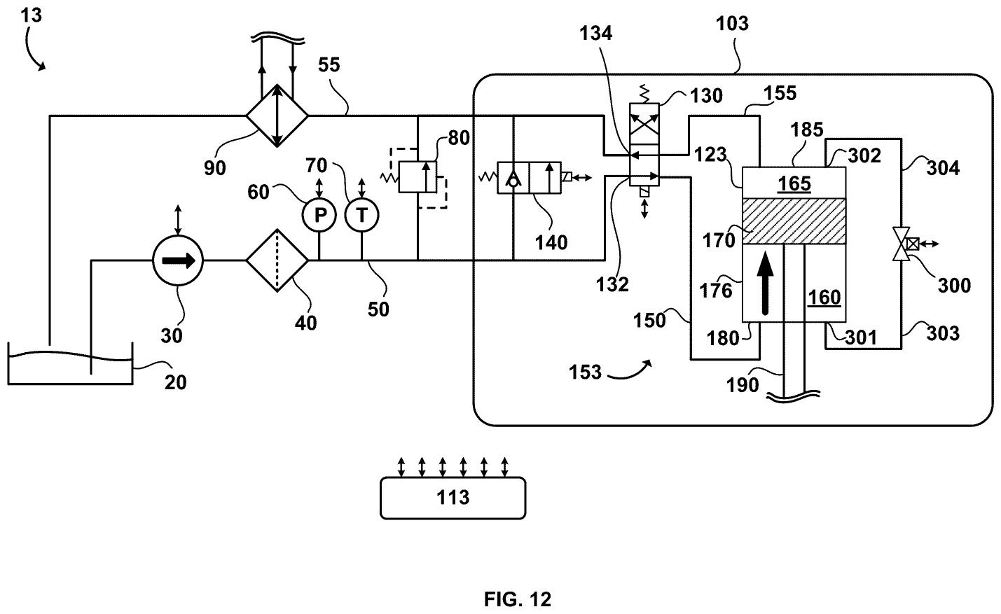

Referring now to FIGS. 11 and 12 there is shown hydraulic system 13 according to another embodiment including piston-bypass valve 300 that is actuatable by controller 113 to a blocking position or a piston-bypass position. In an exemplary embodiment, piston-bypass valve 300 (or any other valve herein that is actuatable by controller 112 or 113) is a solenoid valve that is electromagnetically actuated to move a valve member (not shown) that either opens or closes the valve, and in other embodiments other types of valves can be employed such as hydraulically actuated valves. In the blocking position, valve 300 is in a closed position (that is, closed) and preferably no hydraulic fluid can flow through valve 300. In the piston-bypass position, valve 300 is in an open position (that is, opened) permitting pressurized hydraulic fluid to flow between chambers 160 and 165, in either direction depending on a pressure differential between hydraulic fluid pressure in chambers 160 and 165. Pressurized hydraulic fluid flows from chamber 165 to chamber 160 when piston-bypass valve 300 is in the piston-bypass position and fluid switching valve 130 is in the first actuating position as illustrated in FIG. 11. Pressurized hydraulic fluid flows from chamber 160 to chamber 165 when piston-bypass valve 300 is in the piston-bypass position and fluid switching valve 130 is in the second actuating position as illustrated in FIG. 12. In operation, controller 113 detects the end of the piston stroke (in either the first or second actuating positions) using any conventional technique, such as the techniques discussed heretofore, and commands valve 300 to the open position to allow hydraulic fluid to continue flowing to flush hydraulic fluid from sub-circuit 153 of end-use hydraulic components 103. A fluid volume of sub-circuit 153 in the illustrated embodiment is a sum of fluid volumes of hydraulic lines 150, 155, 303 and 304, of valve 300 and of hydraulic motor 123. Although piston 170 of hydraulic motor 123 does not include a shuttle valve, in other embodiments, piston 172 seen in FIG. 5 including shuttle valve 200 can be employed instead of piston 170, whereby valve 300 can be actuated to increase a flow area between chambers 160 and 165. Returning to FIGS. 11 and 12, cylinder 176 includes ports 301 and 302 in cylinder heads 180 and 185 respectively, although in other embodiments ports 301 and 302 can be in other locations along cylinder 175 between cylinder heads 180 and 185. Hydraulic line 303 connects port 301 to a first side of valve 300, and hydraulic line 304 connects port 302 to a second side of valve 300.

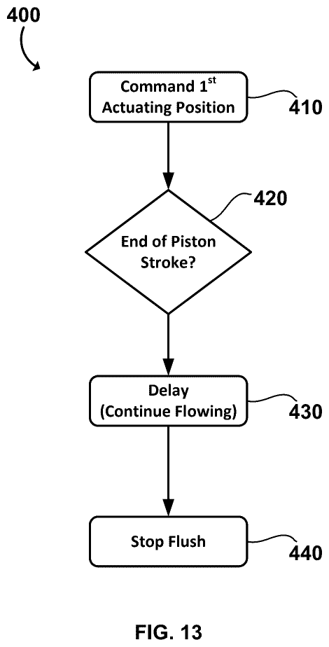

Referring now to FIG. 13, there is shown a flow chart illustrating algorithm 400 for operating hydraulic systems 12 or 13 according to an embodiment. Algorithm 400 will first be described with respect to hydraulic system 12, seen in FIGS. 5 to 10. In step 410 controller 112 commands fluid switching valve 130 and the bypass valve 140 to the first actuating position that is illustrated in FIG. 5. Piston 172 is typically adjacent or near cylinder head 185 and piston-bypass valve 200 is in the second open position (as shown in FIG. 10) when step 410 is performed; however, this is not a requirement and piston 172 can be at other locations within cylinder 175 and piston-bypass valve 200 can be in the second closed position. When hydraulic system 12 is in the first actuating position, pressurized hydraulic fluid from hydraulic pump 30 through hydraulic line 155 causes piston-bypass valve 200 (seen in FIG. 10) to close into the first closed position (seen in FIG. 6) if it is open, or to change from the second closed position (seen in FIG. 9) to the first closed position (seen in FIG. 6). With reference to FIG. 6, piston 172 begins to move towards cylinder head 180 when pressurized hydraulic fluid acts on the piston within chamber 165 when piston-bypass valve 200 is closed. In step 420, controller 112 detects when piston 172 has completed a first stroke and is adjacent or near cylinder head 180 whereby piston-bypass valve 200 opens automatically (seen in FIG. 7). Upon detection of the completed first stroke, controller 112 in step 430 delays commanding fluid switching valve 130 to the second actuating position, bypass valve 140 to the bypass position or hydraulic pump 30 to stop pressurizing the hydraulic fluid such that a quantity of hydraulic fluid is flushed out of sub-circuit 152 through exit port 134. That is, pressurized hydraulic fluid that was recently filtered by filter 40 is fluidly communicated through entry port 132 into hydraulic line 155 thereby displacing hydraulic fluid in chamber 165 through piston-bypass valve 200 and chamber 160 into hydraulic line 150 thereby displacing hydraulic fluid in hydraulic line 150 through exit port 134 into hydraulic return line 55. Filtered hydraulic fluid from hydraulic line 50 entering sub-circuit 152 displaces old hydraulic fluid (that is, hydraulic fluid that was previously in sub-circuit 152) from sub-circuit 152 into hydraulic return line 55. In step 440, after the quantity of hydraulic fluid has been flushed from sub-circuit 152, controller 112 commands fluid switching valve 130 to the second actuating position, bypass valve 140 to the bypass position or hydraulic pump 30 to stop pressurizing the hydraulic fluid. Algorithm 400 can correspond to an extend/compression stroke in the single-acting cryogenic pump where the cryogenic fluid in the pump is pressurized.

Referring now to FIGS. 11 and 13, algorithm 400 is now discussed with respect to hydraulic system 13. In step 410 controller 113 commands fluid switching valve 130 and the bypass valve 140 to the first actuating position illustrated in FIG. 11. Piston 170 is typically adjacent cylinder head 185 and piston-bypass valve 300 is in the open position when step 410 is performed; however, this is not a requirement and piston 170 can be at other locations within cylinder 176 and piston-bypass valve can be in the closed position. Controller 113 commands piston-bypass valve 300 to close in step 410 if it is not already in the closed position. Piston 170 begins to move towards cylinder head 180 when pressurized hydraulic fluid acts on the piston within chamber 165 when piston-bypass valve 300 is closed. In step 420, controller 113 detects when piston 170 has completed a first stroke and is adjacent or near cylinder head 180 and commands piston-bypass valve 300 to open. Upon detection of the completed first stroke, controller 113 in step 430 delays commanding fluid switching valve 130 to the second actuating position, bypass valve 140 to the bypass position or hydraulic pump 30 to stop pressurizing the hydraulic fluid such that the quantity of hydraulic fluid is flushed out of sub-circuit 153 through exit port 134. That is, pressurized hydraulic fluid that was recently filtered by filter 40 is fluidly communicated through entry port 132 into hydraulic line 155 thereby displacing hydraulic fluid in chamber 165 through piston-bypass valve 300 and chamber 160 into hydraulic line 150 thereby displacing hydraulic fluid in hydraulic line 150 through exit port 134 into hydraulic return line 55. Filtered hydraulic fluid from hydraulic line 50 entering sub-circuit 153 displaces old hydraulic fluid (that is, hydraulic fluid that was previously in sub-circuit 153) from sub-circuit 153 into hydraulic return line 55. In step 440, after the quantity of hydraulic fluid has been flushed from sub-circuit 153, controller 113 commands fluid switching valve 130 to the second actuating position, bypass valve 140 to the bypass position or hydraulic pump 30 to stop pressurizing the hydraulic fluid. Algorithm 400 can correspond to an extend/compression stroke in the single-acting cryogenic pump where the cryogenic fluid in the pump is pressurized.

The quantity of hydraulic fluid that is flushed from sub-circuits 152, 153 can be greater than, equal to or less than the fluid volume of sub-circuits 152, 153. Alternatively, or additionally, the quantity of hydraulic fluid flushed from sub-circuits 152, 153 can be that quantity of hydraulic fluid flushed from sub-circuits 152, 153 when hydraulic fluid pressure decreases below a desired value, or that results in a desired pressure drop in hydraulic fluid pressure that occurs during startup of hydraulic systems 12, 13. That is, during startup the hydraulic fluid is more viscous due to its temperature (which can be equal to ambient temperature if the hydraulic system has been inactive for a while) compared to the viscosity of hydraulic fluid during operation, and accordingly there can be a noticeable backpressure in hydraulic systems 12, 13 due to this viscosity that increases hydraulic fluid pressure. After the system has recirculated hydraulic fluid for a while and hydraulic fluid temperature increases and viscosity decreases the backpressure diminishes and the flow improves, and this decrease in backpressure can be detected. Still further, the quantity of hydraulic fluid that is flushed from sub-circuits 152, 153 can be that quantity of hydraulic fluid flushed when a temperature of the hydraulic fluid is within a desired operating temperature range. In an exemplary embodiment the desired operating temperature range is between 50 degrees Celsius and 90 degrees Celsius. Moreover, the quantity of hydraulic fluid flushed from sub-circuits 152, 153 can be the quantity of hydraulic fluid flushed after a desired flush time-interval of delaying (in step 430) has elapsed; and the desired time-interval can be empirically associated with the time it takes to accomplish the above disclosed determinations of the quantity of hydraulic fluid that is flushed from sub-circuits 152, 153. Alternatively, or additionally the quantity of hydraulic fluid flushed from sub-circuits 152, 153 can be the quantity of hydraulic fluid flushed after a desired level or amount of filtration of the hydraulic fluid in hydraulic systems 12, 13 has occurred, for example by a desired volume or mass of hydraulic fluid flowing through filter 40. When hydraulic pump 30 is directly driven by an engine, the flow rate of hydraulic fluid can be directly proportional to engine speed, and in this circumstance the engine speed can be employed to determine a time interval required to circulate the desired volume of hydraulic fluid.

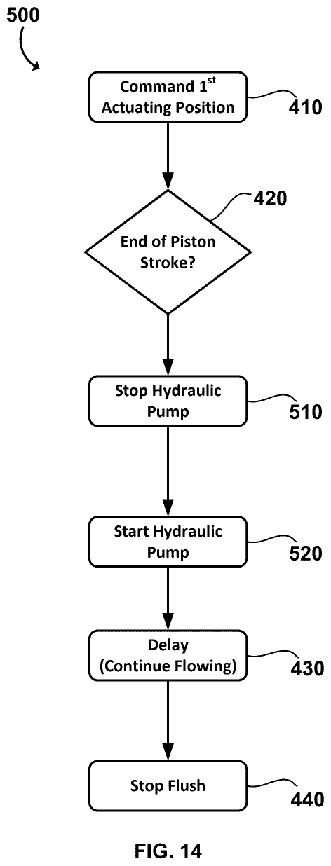

Referring now to FIG. 14, an alternative flow chart is shown illustrating algorithm 500 for operating hydraulic systems 12 or 13 (seen in FIGS. 6 and 11, respectively) according to an embodiment that is similar to algorithm 400 and only the differences are discussed. Between step 420 (where end of piston stroke is detected) and step 430 (where there is a delay allowing flow of hydraulic fluid through piston-bypass valves 200,300), hydraulic pump 30 is stopped in step 510 and then after a first time-interval, hydraulic pump 30 is started again in step 520. The purpose of stopping and then starting hydraulic pump 30 can be for a variety of reasons, such as for deactivating hydraulic motors 122, 123 for the first time-interval, or when hydraulic systems 12, 13 is part of an internal combustion engine system (not shown) the stopping and then starting of hydraulic pump 30 can be associated with an engine shutdown event followed by an engine start event. During the engine start event hydraulic fluid can be recirculated through piston-bypass valves 200,300 to improve and quicken the heating and homogenization of hydraulic fluid within hydraulic systems 12, 13.

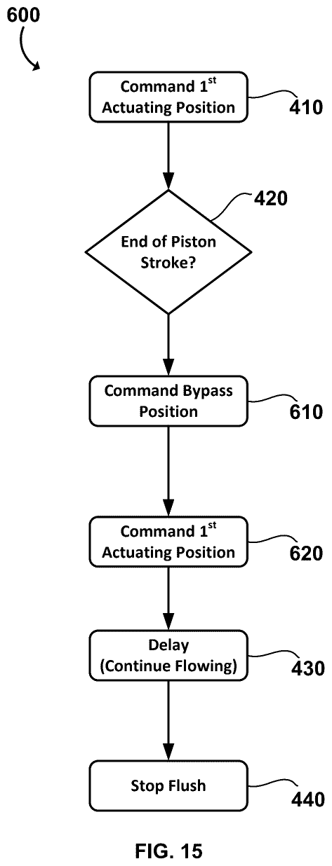

Referring now to FIG. 15, an alternative flow chart is shown illustrating algorithm 600 for operating hydraulic systems 12 or 13 (seen in FIGS. 6 and 11, respectively) according to an embodiment that is similar to algorithm 400 and only the differences are discussed. Between step 420 (where end of piston stroke is detected) and step 430 (where a delay allowing flow of hydraulic fluid through piston-bypass valves 200,300), bypass valve 140 is commanded to the bypass position in step 610 and then after a second time-interval bypass valve 140 and fluid switching valve 130 are commanded to the first actuating position in step 620. The purpose of bypassing sub-circuits 152, 153 of pressurized hydraulic fluid can be for a variety of reasons, such as particularly for deactivating hydraulic motors 122, 123 for the second time-interval.

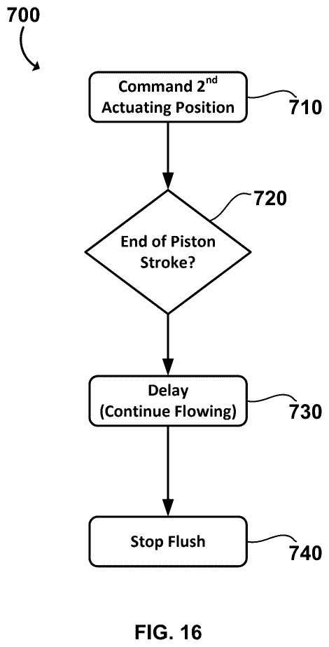

Referring now to FIG. 16, there is shown a flow chart illustrating algorithm 700 for operating hydraulic systems 12 or 13 (seen in FIGS. 8 and 12, respectively) according to an embodiment. Algorithm 700 is the mirror algorithm compared to algorithm 400 in that it reflects a second stroke in the opposite direction to the first stroke. Algorithm 700 will first be described with respect to hydraulic system 12, seen in FIGS. 5 to 10. In step 710 controller 112 commands fluid switching valve 130 and bypass valve 140 to the second actuating position that is illustrated in FIG. 8. Typically, piston 172 is adjacent or near cylinder head 180 and piston-bypass valve 200 is in the first open position when step 710 is performed; however, this is not a requirement and piston 172 can be at other locations within cylinder 175 and piston-bypass valve 200 can be in the first closed position. In the second actuating position, pressurized hydraulic fluid from hydraulic pump 30 through hydraulic line 150 causes piston-bypass valve 200 to close into the second closed position if it is open (seen in FIG. 10), or to change from the first closed position seen in FIG. 5 to the second closed position seen in FIG. 8. Piston 172 begins to move towards cylinder head 185 when pressurized hydraulic fluid acts on the piston within chamber 160 when piston-bypass valve 200 is closed. In step 720, controller 112 detects when piston 172 has completed the second stroke and is adjacent or near cylinder head 185 whereby piston-bypass valve 200 opens into the second open position (seen in FIG. 10). Upon detection of the completed second stroke, controller 112 delays (in step 730) commanding fluid switching valve 130 to the first actuating position, bypass valve 140 to the bypass position or hydraulic pump 30 to stop pressurizing the hydraulic fluid such that a second quantity of hydraulic fluid is flushed out of sub-circuit 152 through exit port 134. That is, pressurized hydraulic fluid that was recently filtered by filter 40 is fluidly communicated through entry port 132 into hydraulic line 150 thereby displacing hydraulic fluid in chamber 160 through piston-bypass valve 200 and chamber 165 into hydraulic line 155 thereby displacing hydraulic fluid in hydraulic line 155 through exit port 134 into hydraulic return line 55. Filtered hydraulic fluid from hydraulic line 50 entering sub-circuit 152 displaces old hydraulic fluid (that is, hydraulic fluid that was previously in sub-circuit 152) from sub-circuit 152 into hydraulic return line 55. In step 740, after the second quantity of hydraulic fluid has been flushed from sub-circuit 152, controller 112 commands fluid switching valve 130 to the second actuating position, bypass valve 140 to the bypass position or hydraulic pump 30 to stop pressurizing the hydraulic fluid. Algorithm 700 can correspond to a retract/suction stroke in the single-acting cryogenic pump where the cryogenic fluid flows into the cryogenic pump before pressurization.

Referring now to FIGS. 12 and 16, algorithm 700 is now discussed with respect to hydraulic system 13. In step 710 controller 113 commands fluid switching valve 130 and bypass valve 140 to the second actuating position illustrated in FIG. 12. Typically, piston 170 is adjacent or near cylinder head 180 and piston-bypass valve 300 is in the open position when step 710 is performed; however, this is not a requirement and piston 170 can be at other locations within cylinder 176 and piston-bypass valve can be in the closed position. Controller 113 commands piston-bypass valve 300 to close in step 710 if it is not already in the closed position. Piston 170 begins to move towards cylinder head 185 when pressurized hydraulic fluid acts on the piston within chamber 160 when piston-bypass valve 300 is closed. In step 720, controller 113 detects when piston 170 has completed the second stroke and is adjacent or near cylinder head 185 and commands piston-bypass valve 300 to the open position. Upon detection of the completed second stroke, controller 113 delays commanding fluid switching valve 130 to the first actuating position, bypass valve 140 to the bypass position or hydraulic pump 30 to stop pressurizing the hydraulic fluid such that the second quantity of hydraulic fluid is flushed out of sub-circuit 153 through exit port 134. That is, pressurized hydraulic fluid that was recently filtered by filter 40 is fluidly communicated through entry port 132 into hydraulic line 150 thereby displacing hydraulic fluid in chamber 160 through piston-bypass valve 200 and chamber 165 into hydraulic line 155 thereby displacing hydraulic fluid in hydraulic line 155 through exit port 134 into hydraulic return line 55. Filtered hydraulic fluid from hydraulic line 50 entering sub-circuit 153 displaces old hydraulic fluid (that is, hydraulic fluid that was previously in sub-circuit 153) from sub-circuit 153 into hydraulic return line 55. In step 740, after the second quantity of hydraulic fluid has been flushed from sub-circuit 153, controller 113 commands fluid switching valve 130 to the second actuating position, bypass valve 140 to the bypass position or hydraulic pump 30 to stop pressurizing the hydraulic fluid. Algorithm 700 can correspond to a retract or suction stroke in the single-acting cryogenic pump where the cryogenic fluid flows into the cryogenic pump before pressurization.

The second quantity of hydraulic fluid can be the same as the quantity of hydraulic fluid defined according to algorithm 400 in FIG. 13. Although algorithms 400 and 700 can be performed sequentially from piston stroke to subsequent piston stroke, typically there are two or more piston strokes between the execution of algorithms 400 and algorithm 700; that is, two or more piston strokes that do not involve flushing of hydraulic fluid from sub-circuits 152, 153 (seen in FIGS. 5 to 10 and FIGS. 11 to 12, respectively). Algorithm 700 can be adapted like algorithm 400 to includes steps illustrated in algorithm 500 or algorithm 600 in other embodiments.

The technique of clearing or flushing hydraulic fluid from sub-circuits 152, 153 according to algorithms 400, 500, 600 and 700 has positive effects not only for the cleanliness of the hydraulic fluid within the sub-circuit, but also for fluid viscosity and temperature. The fluid volumes within sub-circuits 152, 153 as well as an instantaneous hydraulic fluid flow rate are known in hydraulic systems 12, 13, which allows for the calculation of the duration that the fluid flow must be maintained to replace the entire fluid volume. In an internal combustion engine application, the instantaneous hydraulic fluid flow rate can be a function of engine speed. The duration of free flow required to clear sub-circuits 152, 153 of ‘used’ or ‘dirty’ hydraulic fluid (that is, the old hydraulic fluid) can be tuned based on the engine speed (i.e., hydraulic flow rate) to reduce parasitic load. A shorter duration is required at higher flow rates. The time to enter a cleaning mode would be whenever a low probability of a pump stroke can be predicted long enough into the future to be able to complete fluid replacement. Aside from keeping sub-circuit 152, 153 clean, there may be other reasons to enter the cleaning mode, such as part of a warm-up routine after cold start, or potentially during high load drive cycles to mitigate localized heating effects.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. An apparatus for recirculating hydraulic fluid in a hydraulic system, the hydraulic system including a hydraulic pump, a bypass valve, a sub-circuit and a controller, the hydraulic pump pressurizing hydraulic fluid for circulation through the hydraulic system, the sub-circuit comprising a fluid switching valve, a piston-bypass valve, a cylinder and a piston reciprocating therein between first and second cylinder heads, the piston dividing the cylinder between a first chamber adjacent the first cylinder head and a second chamber adjacent the second cylinder head, first and second hydraulic lines fluidly connecting the first and second chambers to the fluid switching valve, respectively, hydraulic fluid entering and leaving the sub-circuit through entry and exit ports on the fluid switching valve, respectively, the piston-bypass valve selectively fluidly connecting the first and second chambers, the controller operatively connected to the fluid switching valve and programmed to command first and second actuating positions, in the first actuating position the entry and exit ports are fluidly connected to the second and first chambers through the second and first hydraulic lines, respectively, in the second actuating position the entry and exit ports are fluidly connected to the first and second chambers through the first and second hydraulic lines, respectively, the controller operatively connected to the bypass valve and programmed to command the bypass valve to a bypass position where pressurized hydraulic fluid bypasses the sub-circuit, the apparatus comprising the controller programmed to:
command the fluid switching valve to the first actuating position, the piston-bypass valve being closed such that pressurized hydraulic fluid moves the piston towards the first cylinder head;
detect when the piston has completed a first stroke and is adjacent the first cylinder head;
delay commanding:
the fluid switching valve to the second actuating position,
the bypass valve to the bypass position, or
the hydraulic pump to stop pressurizing the hydraulic fluid,
the piston-bypass valve being open such that hydraulic fluid is fluidly communicated into the sub-circuit through the entry port and through the piston-bypass valve wherein a quantity of hydraulic fluid is flushed out of the sub-circuit through the exit port; and
command:
the fluid switching valve to the second actuating position,
the bypass valve to the bypass position, or
the hydraulic pump to stop pressurizing the hydraulic fluid.

2. The apparatus as claimed in claim 1, wherein the piston-bypass valve is a shuttle valve configured in the piston, pressurized hydraulic fluid closing the shuttle valve in the first actuating position at the beginning of the first stroke and the shuttle valve opening when the piston completes the first stroke.

3. The apparatus as claimed in claim 1, wherein the controller is operatively connected with the piston-bypass valve and programmed to command the piston-bypass valve to close at the beginning of the first stroke and to open when the first stroke is completed.

4. The apparatus as claimed in claim 1, wherein when the controller commands the fluid switching valve to the second actuating position, the controller is further programmed to also command the piston-bypass valve to close.

5. The apparatus as claimed in claim 1, wherein between the steps of detecting and delaying, the controller is further programmed to stop the hydraulic pump and then restart the hydraulic pump after a time interval.

6. The apparatus as claimed in claim 1, wherein between the steps of detecting and delaying, the controller is further programmed to command the bypass valve to the bypass position and then to a non-bypass position after a time interval.

7. The apparatus as claimed in claim 1, wherein when the fluid switching valve was commanded to the second actuating position, and the piston-bypass valve is closed, the controller is further programmed to:
detect when the piston has completed a second stroke and is adjacent the second cylinder head;
delay commanding:
the fluid switching valve to the first actuating position,
the bypass valve to the bypass position, or
the hydraulic pump to stop pressurizing the hydraulic fluid,
the piston-bypass valve being open such that hydraulic fluid is fluidly communicated into the sub-circuit through the entry port and through the piston-bypass valve wherein the quantity of hydraulic fluid is flushed out of the sub-circuit through the exit port; and
command:
the fluid switching valve to the first actuating position,
the bypass valve to the bypass position, or
the hydraulic pump to stop pressurizing the hydraulic fluid.

8. The apparatus of claim 1, wherein the bypass valve is part of the fluid switching valve, whereby the fluid switching valve is actuatable to the first actuating position, the second actuating position and the bypass position.

9. The apparatus of claim 1, wherein the quantity of hydraulic fluid that is flushed out of the sub-circuit is greater than, equal to or less than a fluid volume of the sub-circuit.

10. The apparatus as claimed in claim 1, wherein the quantity of hydraulic fluid flushed out of the sub-circuit is the quantity of hydraulic fluid flushed when a temperature of the hydraulic fluid is within a desired operating temperature range.

11. The apparatus as claimed in claim 1, wherein a desired operating temperature range is between 50 degrees Celsius and 90 degrees Celsius.

12. The apparatus as claimed in claim 1, wherein the quantity of hydraulic fluid flushed out of the sub-circuit is the quantity of hydraulic fluid flushed after a flush time-interval.

13. The apparatus as claimed in claim 1, wherein the quantity of hydraulic fluid flushed out of the sub-circuit is the quantity of hydraulic fluid flushed when a pressure of hydraulic fluid decreases below a desired value.

14. A method for recirculating hydraulic fluid in a hydraulic system, the hydraulic system including a hydraulic pump, a bypass valve, a sub-circuit and a controller, the hydraulic pump pressurizing hydraulic fluid for circulation through the hydraulic system, the sub-circuit comprising a fluid switching valve, a piston-bypass valve, a cylinder and a piston reciprocating therein between first and second cylinder heads, the piston dividing the cylinder between a first chamber adjacent the first cylinder head and a second chamber adjacent the second cylinder head, first and second hydraulic lines fluidly connecting the first and second chambers to the fluid switching valve, respectively, hydraulic fluid entering and leaving the sub-circuit through entry and exit ports on the fluid switching valve, respectively, the piston-bypass valve selectively fluidly connecting the first and second chambers, the controller operatively connected to the fluid switching valve and programmed to command first and second actuating positions, in the first actuating position the entry and exit ports are fluidly connected to the second and first chambers through the second and first hydraulic lines, respectively, in the second actuating position the entry and exit ports are fluidly connected to the first and second chambers through the first and second hydraulic lines, respectively, the controller operatively connected to the bypass valve and programmed to command the bypass valve to a bypass position where pressurized hydraulic fluid bypasses the sub-circuit, the method comprising:
supplying pressurized hydraulic fluid to the second chamber and closing the piston-bypass valve to move the piston towards the first cylinder head;
detecting when the piston has completed a first stroke and is adjacent the first cylinder head;
delaying:
supplying pressurized hydraulic fluid to the first chamber and closing the piston-bypass valve to cause the piston to move towards the second cylinder head,
bypassing the pressurized hydraulic fluid from the sub-circuit, or
stopping the hydraulic pump that pressurizes the hydraulic fluid through the piston-bypass valve,
the piston-bypass valve being open such that hydraulic fluid is fluidly communicated into the sub-circuit through the entry port and through the piston-bypass valve wherein a quantity of hydraulic fluid is flushed out of the sub-circuit through the exit port; and
performing after the quantity of hydraulic fluid is flushed out of the sub-circuit:
supplying pressurized hydraulic fluid to the first chamber and closing the piston-bypass valve to cause the piston to move towards the second cylinder head,
bypassing the pressurized hydraulic fluid from the sub-circuit, or
stopping the hydraulic pump from pressurizing the hydraulic fluid.

15. The method as claimed in claim 14, wherein between the steps of detecting and delaying, further comprising stopping a hydraulic pump that pressurizes and supplies hydraulic fluid to the sub-circuit and then restarting the hydraulic pump after a time interval.

16. The method as claimed in claim 14, wherein between the steps of detecting and delaying, further comprising bypassing hydraulic fluid from the sub-circuit and then supplying the hydraulic fluid to the sub-circuit after a time interval.

17. The method of recirculating hydraulic fluid of claim 14, wherein when pressurized hydraulic fluid was supplied to the first chamber and the piston-bypass valve is closed to cause the piston to move towards the second cylinder head:
detecting when the piston has completed a second stroke and is adjacent the second cylinder head, the piston-bypass valve being opened such that pressurized hydraulic fluid is fluidly communicated through the piston-bypass valve;
delaying:
supplying pressurized hydraulic fluid to the second chamber and closing the piston-bypass valve to cause the piston to move towards the first cylinder head,
bypassing the pressurized hydraulic fluid from the sub-circuit, or
stopping the hydraulic pump that pressurizes the hydraulic fluid through the piston-bypass valve,
the piston-bypass valve being open such that hydraulic fluid is fluidly communicated into the sub-circuit through the entry port and through the piston-bypass valve wherein the quantity of hydraulic fluid is flushed out of the sub-circuit through the exit port; and
performing after the quantity of hydraulic fluid is flushed out of the sub-circuit:
supplying pressurized hydraulic fluid to the second chamber and closing the piston-bypass valve to cause the piston to move towards the first cylinder head,
bypassing the pressurized hydraulic fluid from the sub-circuit, or
stopping the hydraulic pump from pressurizing the hydraulic fluid.

18. The method of claim 14, wherein the quantity of hydraulic fluid that is flushed out of the sub-circuit is greater than, equal to or less than a fluid volume of the sub-circuit.

19. The method as claimed in claim 14, wherein the quantity of hydraulic fluid flushed out of the sub-circuit is the quantity of hydraulic fluid flushed when a temperature of the hydraulic fluid is within a desired operating temperature range or when a pressure of hydraulic fluid decreases below a desired value.

20. The method as claimed in claim 14, wherein the quantity of hydraulic fluid flushed out of the sub-circuit is the quantity of hydraulic fluid flushed after a flush time-interval.
